(19) United States
(12) Patent Application Publication
(10) Pub. No.: US 2022/0231824 A1
(43) Pub. Date: Jul. 21, 2022

(54) DATA TRANSMISSION METHOD, APPARATUS, AND DEVICE, AND STORAGE MEDIUM

(71) Applicant: BEIJING XIAOMI MOBILE SOFTWARE CO., LTD., Beijing (CN)

(72) Inventor: Xiandong DONG, Beijing (CN)

(73) Assignee: BEIJING XIAOMI MOBILE SOFTWARE CO., LTD., Beijing (CN)

(21) Appl. No.: 17/612,922

(22) PCT Filed: May 23, 2019
(86) PCT No.: PCT/CN2019/088135

§ 371 Date: Nov. 19, 2021

(51) Int. Cl. H04L 5/00; H04W 36/28; H04W 74/00; H04W 76/15; H04W 74/08

(52) U.S. Cl. CPC H04L 5/0098; H04W 36/28; H04W 74/006; H04W 84/12; H04W 74/0816; H04W 74/085; H04W 76/15

(57) ABSTRACT

A data transmission method, apparatus, and device, and a storage medium are provided. The method includes: a first device generating a multi-frequency band transmission connection establishment message frame, where the multi-frequency band transmission connection establishment message frame requests the simultaneous sending of data frames on at least two frequency bands; the first device sending the multi-frequency band transmission connection establishment message frame on the at least two frequency bands; and the first device sending the data frames on all or part of the frequency bands among the at least two frequency bands.

### CROSS-REFERENCE

This application is the U.S. national phase application of International Application No. PCT/CN2019/088135, filed May 23, 2019, the contents of which are incorporated herein by reference in their entirety for all purposes.

### TECHNICAL FIELD

The present disclosure relates to the field of communications, and in particular to a data transmission method, an apparatus, a device, and a storage medium.

### BACKGROUND

In the next generation of wireless fidelity (Wi-Fi) technologies, a research scope includes: 320 MHz bandwidth transmission, aggregation and coordination transmission of multiple frequency bands, etc. The proposed vision improves speed and throughput by at least four times compared with the existing Institute of Electrical and Electronics Engineers (IEEE) 802.11ax. Main application scenarios include video transmission, augmented reality (AR), virtual reality (VR), etc.

The aggregation and coordination transmission of multiple frequency bands refer to simultaneous communication between devices on frequency bands of 2.4 GHz, 5.8 GHz, and 6-7 GHz. In addition, the multiple frequency bands can also include millimeter wave frequency bands, such as 45 GHz and 60 GHz frequency bands.

### SUMMARY

The present disclosure provide a data transmission method, an apparatus, a device, and a storage medium.

According to a first aspect of the present disclosure, there is provided a data transmission method, and the method includes: generating a multi-band transmission connection establishment message frame, where the multi-band transmission connection establishment message frame is used to request simultaneous transmission of data frames on at least two frequency bands; sending the multi-band transmission connection establishment message frame on the at least two frequency bands; and sending the data frames on all or part of the at least two frequency bands.

According to a second aspect of the present disclosure, there is provided a data transmission method, and the method includes: receiving a multi-band transmission connection establishment message frame on at least two frequency bands, where the multi-band transmission connection establishment message frame is used to request simultaneous transmission of data frames on at least two frequency bands; and receiving the data frames on all or part of the at least two frequency bands.

According to a third aspect of the present disclosure, there is provided a data transmission apparatus, and the apparatus includes a processor and a memory for storing executable instructions of the processor. The processor is configured to execute following operations when executing the executable instructions including: generating a multi-band transmission connection establishment message frame, where the multi-band transmission connection establishment message frame is used to request simultaneous transmission of data frames on at least two frequency bands; sending the multi-band transmission connection establishment message frame on the at least two frequency bands; and sending the data frames on all or part of the at least two frequency bands.

According to a fourth aspect of the present disclosure, there is provided a data transmission apparatus, and the apparatus includes a processor and a memory for storing executable instructions of the processor. The processor is configured to execute the method according to the second aspect.

According to a fifth aspect of the present disclosure, there is provided a computer-readable storage medium having stored therein at least one instruction, at least one program, a code set or an instruction set, wherein the at least one instruction, the at least one program, the code set or the instruction set is loaded and executed by a processor to implement the data transmission method described above.

### BRIEF DESCRIPTION OF THE DRAWINGS

In order to explain technical solutions in embodiments of the present disclosure more clearly, the following will briefly introduce drawings needed in the description of the embodiments. Obviously, the drawings in the following description are only some embodiments of the present disclosure. For those of ordinary skill in the art, other drawings can be obtained from these drawings without creative labor.

FIG. 1 is a block diagram of a communication system provided by an embodiment of the present disclosure;

FIG. 2 is a flowchart of a data transmission method provided by an embodiment of the present disclosure;

FIG. 3 is a flowchart of a data transmission method provided by an embodiment of the present disclosure;

FIG. 4 is a flowchart of a data transmission method provided by another embodiment of the present disclosure;

FIG. 5 is a flowchart of a data transmission method provided by another embodiment of the present disclosure;

FIG. 6 is a flowchart of a data transmission method provided by another embodiment of the present disclosure;

FIG. 7 is a flowchart of a random back-off mechanism on multiple frequency bands provided by another embodiment of the present disclosure;

FIG. 8 is a schematic diagram of a data transmission method provided by another embodiment of the present disclosure;

FIG. 9 is a schematic structural diagram of a data transmission apparatus provided by an embodiment of the present disclosure;

FIG. 10 is a schematic structural diagram of a data transmission apparatus provided by another embodiment of the present disclosure; and

FIG. 11 is a schematic structural diagram of a wireless communication device provided by another embodiment of the present disclosure.

### DETAILED DESCRIPTION

In order to make objectives, technical solutions, and advantages of the present disclosure clearer, the following will further describe embodiments of the present disclosure in detail with reference to the drawings.

Reference throughout this specification to “one embodiment,” “an embodiment,” “an example,” “some embodiments,” “some examples,” or similar language means that a particular feature, structure, or characteristic described is included in at least one embodiment or example. Features, structures, elements, or characteristics described in connection with one or some embodiments are also applicable to other embodiments, unless expressly specified otherwise.

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another.

A communication system and a business scenario described in the embodiments of the present disclosure are intended to explain the technical solutions of embodiments of the present disclosure more clearly, and do not constitute a limitation to the technical solutions provided by the embodiments of the present disclosure. The ordinary technicians in the art know that, with the evolution of the communication system and the emergence of new business scenarios, the technical solutions provided by the embodiments of the present disclosure are equally applied to similar technical issues.

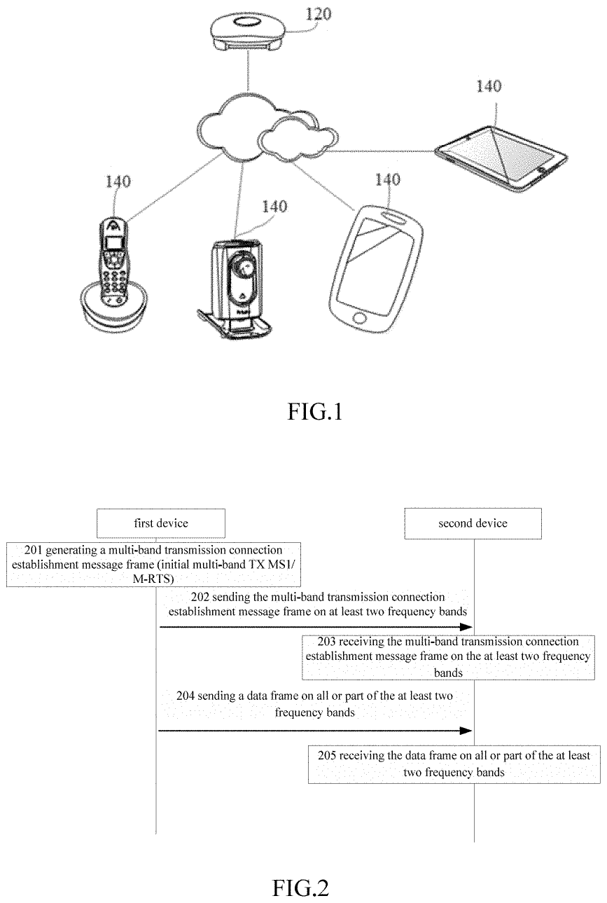

FIG. 1 shows a block diagram of a communication system provided by an embodiment of the present disclosure, and the communication system includes: a wireless access point (AP) 120 and a station 140.

The wireless access point 120 is used to provide a wireless access function, and may be a wireless router, a base station with a Wi-Fi function, or the like. Multiple stations 140 can access one wireless access point 120.

The station 140 accesses the wireless access point 120, and may be an apparatus such as a mobile phone, a tablet, a laptop, an e-book and an industrial machine.

The communication system may be an Institute of Electrical and Electronics Engineers (IEEE) 802.11a/b/g/n/ac/ax/be. In the embodiments of the present disclosure, the communication system being IEEE 802.11 be is taken as an example for description.

The communication system includes two networking forms:

a first form: an underlying wireless network organized based on the AP 120 (also called an Infra network or underlying network), which is a wireless network which is created by the AP 120 and many STAs 140 access; characteristics of such network are in that the AP 120 is the center of the entire network, and all communications in the network are forwarded through the AP 120.

In this networking situation, a first device in the present disclosure may be one of the wireless access point 120 and the station 140, and a second device may be the other of the wireless access point 120 and the station 140.

A second form: a wireless network based on an ad-hoc network (also called an ad-hoc network), which is a network composed of only two or more STAs 140 themselves, and there is no AP 120 in the network; such network has a loose structure, and all STAs 140 in the network can communicate directly.

In this networking situation, the first device in the present disclosure may be a first station 140, and the second device may be a second station 140.

A request to send (RTS)/clear to send (CTS) handshake mechanism has been widely used to solve a hidden terminal problem in a wireless network. The RTS/CTS handshake mechanism (the original handshake mechanism) stipulates that a first device has to send an RTS request frame to a second device before officially sending a data packet to the adjacent second device; after the second device receives the RTS request, and if the second device determines that there are no hidden terminals around it, the second device returns a CTS reply frame to the first device; otherwise, the second device makes no response; only after receiving the CTS reply frame returned by the second device, the first device can send a data frame (DATA) to the second device; and after receiving the data frame from the first device, the second device needs to send a reply acknowledgement (ACK) frame to the first device.

FIG. 2 shows a flowchart of a data transmission method provided by an embodiment of the present disclosure. The method can be executed by the communication system shown in FIG. 1, and includes:

In step 201, the first device generates a multi-band transmission connection establishment message frame, and the multi-band transmission connection establishment message frame is used to request simultaneous transmission of data frames on at least two frequency bands.

The multi-band transmission connection establishment message frame is realized by using a management message frame or a control message frame.

In a case where the management message frame is used to realize the multi-band transmission connection establishment message frame, the management message frame may be an initial multi-band transmission request message frame (initial multi-band TX MS1); and in a case where the control message frame is used to realize the multi-band transmission connection establishment message frame, the control message frame may be a multi-band request to send (M-RTS) message frame.

In step 202, the first device sends the multi-band transmission connection establishment message frame on the at least two frequency bands.

The at least two frequency bands include: at least two frequency bands of the 2.4 GHz frequency band, the 5.8 GHz frequency band, and the 6-7 GHz frequency band. In some embodiments, the at least two frequency bands also include other communication frequency bands supported by a Wi-Fi protocol. For example, the at least two frequency bands also include millimeter wave frequency bands, such as the 45 GHz frequency band and the 60 GHz frequency band. In the embodiments of the present disclosure, the at least two frequency bands including three frequency bands of the 2.4 GHz frequency band, the 5.8 GHz frequency band, and the 6-7 GHz frequency band is taken as an example for illustration, but the embodiments of the present disclosure is not limited to this.

The first device simultaneously sends the multi-band transmission connection establishment message frame on the at least two frequency bands.

In step 203, the second device receives the multi-band transmission connection establishment message frame on the at least two frequency bands.

In some embodiments, the second device also replies a multi-band clear to send (M-CTS) message frame to the first device on the at least two frequency bands, and the first device receives the M-CTS message frame from the second device on the at least two frequency bands.

In step 204, the first device sends the data frames on all or part of the at least two frequency bands.

In step 205, the second device receives the data frames on all or part of the at least two frequency bands.

In summary, in the method provided by the embodiments of the present disclosure, by generating the multi-band transmission connection establishment message frame which is used to request the simultaneous transmission of the data frames on the at least two frequency bands, and sending the multi-band transmission connection establishment message frame, the data frames are sent on all or part of the at least two frequency bands, thereby achieving simultaneous data transmission on multiple frequency bands, and achieving greater transmission rate and throughput.

In the embodiments of the present disclosure, steps executed by the first device can be separately implemented as a data transmission method on the first device side, and steps executed by the second device can be separately implemented as a data transmission method on the second device side.

Both the first device and the second device supporting to perform data transmission on all candidate frequency bands (such as the three frequency bands of the 2.4 GHz frequency band, the 5.8 GHz frequency band and the 6-7 GHz frequency band), and the three frequency bands of the 2.4 GHz frequency band, the 5.8 GHz frequency band and the 6-7 GHz frequency band being all in a channel idle state are taken as an example, and the present disclosure provides the following embodiments.

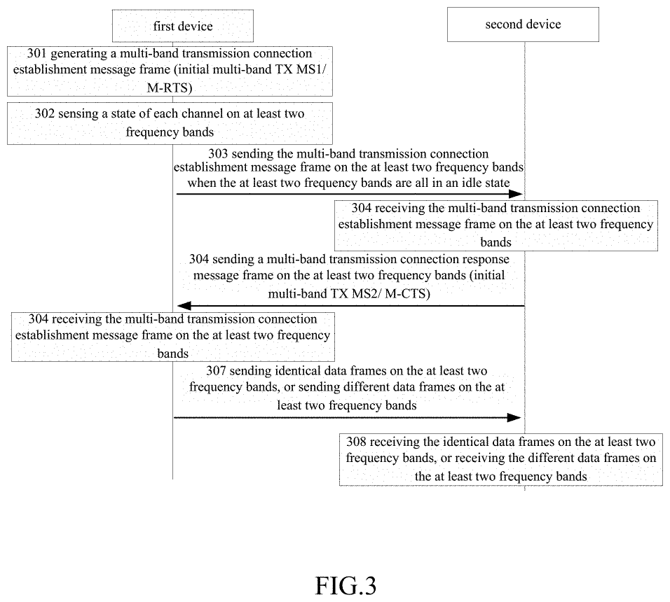

FIG. 3 shows a flowchart of a data transmission method provided by another embodiment of the present disclosure. The method can be executed by the communication system shown in FIG. 1, and the method includes:

In step 301, the first device generates a multi-band transmission connection establishment message frame, and the multi-band transmission connection establishment message frame is used to request simultaneous transmission of data frames on at least two frequency bands.

The multi-band transmission connection establishment message frame is realized by using a management message frame or a control message frame.

In a case where the management message frame is used to realize the multi-band transmission connection establishment message frame, the management message frame may be an initial multi-band transmission request message frame (initial multi-band TX MS1); and in a case where the control message frame is used to realize the multi-band transmission connection establishment message frame, the control message frame may be a multi-band request to send (M-RTS) message frame.

In step 302, the first device senses a state of each channel on the at least two frequency bands.

The first device senses the state of each channel on the at least two frequency bands by using a clear channel assessment (CCA). For example, an energy detection (ED) mechanism is used at a physical layer to sense a signal strength on the channel in the multiple frequency bands; if the sensed signal strength exceeds a threshold, the channel state is determined to be busy; if the sensed signal strength is below the threshold, the channel state is determined to be idle.

In some embodiments, to ensure backward compatibility, the CCA mechanism adopted in the embodiment is consistent with a CCA mechanism in IEEE 802.11a/b/g/n/ac/ax.

In step 303, the first device sends the multi-band transmission connection establishment message frame on the at least two frequency bands when the at least two frequency bands are all in the idle state.

In step 304, the second device receives the multi-band transmission connection establishment message frame on the at least two frequency bands.

In step 305, the second device sends a multi-band transmission connection response message frame on the at least two frequency bands.

The multi-band transmission connection response message frame is realized by using the management message frame or the control message frame. When the second device determines that a data receiving condition is met (for example, there is no conflicting transmission of a hidden node), the second device replies with the multi-band transmission connection response message frame on the at least two frequency bands.

In a case where the management message frame is used to realize the multi-band transmission connection response message frame, the management message frame may be an initial multi-band transmission response message frame (initial multi-band TX MS2); and in a case where the control message frame is used to realize the multi-band transmission connection response message frame, the control message frame may be a multi-band clear to send (M-CTS) message frame.

In step 306, the first device receives the multi-band transmission connection response message frame on the at least two frequency bands.

In step 307, the first device sends identical data frames on the at least two frequency bands; or, sends different data frames on the at least two frequency bands.

The different data frames are obtained after data to be sent is divided into blocks. The data in the different data frames refers to upper layer data, and the upper layer data can be divided into the blocks through a media access control (MAC) layer inside a device. For example, after 100M bytes of data are divided into three blocks and numbered as three different data frames of Block1, Block2 and Block3, these three data frames are transmitted on the frequency bands of 2.4 GHz, 5.8 GHz and 6-7 GHz, respectively; or, the data is divided into the blocks and numbered above the MAC layer inside the device, and transparently transmitted to the MAC layer, after the data is re-encapsulated by the MAC layer to obtain three different data frames, these three data frames are transmitted on the frequency bands of 2.4 GHz, 5.8 GHz and 6-7 GHz, respectively.

The data in the identical data frames also refers to the upper layer data, which can be processed by the MAC layer inside the device to be added with different identifications for transmission on different frequency bands. For example, identification 1 indicates that the data is transmitted on the 2.4 GHz frequency band, identification 2 indicates that the data is transmitted on the 5.8 GHz frequency band, and identification 3 indicates that the data is transmitted on the 6-7 GHz frequency band; or the data is processed by the upper layer, and is transparently transmitted to the MAC layer. After being encapsulated into the data frame by the MAC layer, the data is transmitted on the frequency bands of 2.4 GHz, 5.8 GHz and 6-7 GHz, respectively.

In some embodiments, after receiving the multi-band transmission connection response message frame, the first device simultaneously sends the identical data frames on the at least two frequency bands; or, simultaneously sends the different data frames on the at least two frequency bands.

In step 308, the second device receives the identical data frames on the at least two frequency bands; or, receives the different data frames on the at least two frequency bands.

For example, at a first time, a data frame 1 is sent on the frequency band A, a data frame 2 is sent on the frequency band B, and a data frame 3 is sent on the frequency band C; at a second time, a data frame 4 is sent on the frequency band A, a data frame 5 is sent on the frequency band B, and a data frame 6 is sent on the frequency band C; and at a third time, a data frame 7 is sent on the frequency band A, a data frame 8 is sent on the frequency band B, and a data frame 9 is sent on the frequency band C.

In summary, in the method provided by the embodiments of the present disclosure, by generating the multi-band transmission connection establishment message frame which is used to request the simultaneous transmission of the data frames on the at least two frequency bands, and sending the multi-band transmission connection establishment message frame, the data frames are sent on all or part of the at least two frequency bands, thereby achieving simultaneous data transmission on multiple frequency bands, and achieving greater transmission rate and throughput.

In the method provided by the embodiments of the present disclosure, when the first device sends the identical data frames on the at least two frequency bands, the second device can simultaneously receive the identical data frames on the at least two frequency bands, thereby receiving multiple copies of the same data frame to improve the correct rate of decoding.

In the method provided by the embodiments of the present disclosure, when the first device sends the different data frames on the at least two frequency bands, the second device can receive the different data frames on the at least two frequency bands, thereby achieving a greater transmission rate and throughput.

Regarding the foregoing step 204, since the first device simultaneously sends the data frames on the multiple frequency bands, it may occur a case where some frequency bands are occupied by other devices. Therefore, the present disclosure provide the following embodiments.

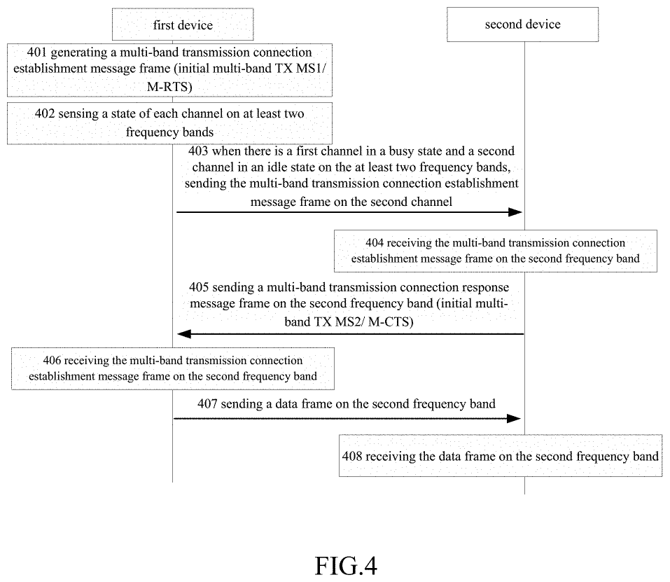

FIG. 4 shows a flowchart of a data transmission method provided by another embodiment of the present disclosure. The method can be executed by the communication system shown in FIG. 1, and includes:

In step 401, the first device generates a multi-band transmission connection establishment message frame, and the multi-band transmission connection establishment message frame is used to request simultaneous transmission of data frames on at least two frequency bands.

The multi-band transmission connection establishment message frame is realized by using a management message frame or a control message frame.

In a case where the management message frame is used to realize the multi-band transmission connection establishment message frame, the management message frame may be an initial multi-band transmission request message frame (initial multi-band TX MS1); and in a case where the control message frame is used to realize the multi-band transmission connection establishment message frame, the control message frame may be a multi-band request to send (M-RTS) message frame.

In step 402, the first device senses a state of each channel on the at least two frequency bands.

The first device senses the state of each channel on the at least two frequency bands by using a clear channel assessment (CCA). For example, an energy detection (ED) mechanism is used at a physical layer to sense a signal strength on the channel in multiple frequency bands; if the sensed signal strength exceeds a threshold, the channel state is determined to be busy; if the sensed signal strength is below the threshold, the channel state is determined to be idle.

In some embodiments, to ensure backward compatibility, the CCA mechanism adopted in the embodiment is consistent with a CCA mechanism in IEEE 802.11a/b/g/n/ac/ax.

In step 403, the first device sends the multi-band transmission connection establishment message frame on a second channel when there is a first channel in a busy state and a second channel in an idle state on the at least two frequency bands.

When the second channel refers to one channel, the multi-band transmission connection establishment message frame can be regarded as a single-band transmission connection establishment message frame; when the second channel refers to two or more channels, the first device simultaneously sends the multi-band transmission connection establishment message frame on the at least two second channels.

The multi-band transmission connection establishment message frame is realized by using a management message frame or a control message frame.

In a case where the management message frame is used to realize the multi-band transmission connection establishment message frame, the management message frame may be an initial multi-band transmission request message frame (initial multi-band TX MS1); and in a case where the control message frame is used to realize the multi-band transmission connection establishment message frame, the control message frame may be a multi-band request to send (M-RTS) message frame.

In step 404, the second device receives the multi-band transmission connection establishment message frame on the second channel.

In step 405, the second device replies with the multi-band transmission connection response message frame on the second channel.

The multi-band transmission connection response message frame is realized by using the management message frame or the control message frame. When the second device determines that a data receiving condition is met (for example, there is no conflicting transmission of a hidden node), the second device replies with the multi-band transmission connection response message frame on the at least two frequency bands.

In a case where the management message frame is used to realize the multi-band transmission connection response message frame, the management message frame may be an initial multi-band transmission response message frame (initial multi-band TX MS2); and in a case where the control message frame is used to realize the multi-band transmission connection response message frame, the control message frame may be a multi-band clear to send (M-CTS) message frame.

When the second channel refers to a single channel, the multi-band transmission connection response message frame can be regarded as a single-band transmission connection response message frame.

In Step 406, the first device receives the multi-band transmission connection response message frame on the second frequency band.

In step 407, the first device sends the data frames on the second channel.

When the second channel refers to the single channel and the at least two frequency bands are used to send the identical data frames, the first device sends the data frames on the second channel; and when the second channel refers to the single channel and the at least two frequency bands are used to send the different data frames, a data frame with the smallest frame number among the multiple data frames that have not been sent is sent on the second channel. The different data frames are obtained after the data to be sent is divided into the blocks.

When the second channel refers to at least two channels and the at least two frequency bands are used to send the identical data frames, the first device sends the identical data frames on the at least two second channels; when the second channel refers to the at least two channels and the at least two frequency bands are used to send the different data frames, the first device sends the different data frames on the at least two second channels.

The different data frames are obtained after data to be sent is divided into blocks. The data in the different data frames refers to upper layer data, and the upper layer data can be divided into the blocks through a media access control (MAC) layer inside a device. For example, after 100M bytes of data are divided into three blocks and numbered as three different data frames of Block1, Block2 and Block3, these three data frames are transmitted on the frequency bands of 2.4 GHz, 5.8 GHz and 6-7 GHz, respectively; or, the data is divided into the blocks and numbered above the MAC layer inside the device, and transparently transmitted to the MAC layer, after the data is re-encapsulated by the MAC layer to obtain three different data frames, these three data frames are transmitted on the frequency bands of 2.4 GHz, 5.8 GHz and 6-7 GHz, respectively.

The data in the identical data frames also refers to the upper layer data, which can be processed by the MAC layer inside the device to be added with different identifications for transmission on different frequency bands. For example, identification 1 indicates that the data is transmitted on the 2.4 GHz frequency band, identification 2 indicates that the data is transmitted on the 5.8 GHz frequency band, and identification 3 indicates that the data is transmitted on the 6-7 GHz frequency band; or the data is processed by the upper layer, and is transparently transmitted to the MAC layer. After being encapsulated into the data frame by the MAC layer, the data is transmitted on the frequency bands of 2.4 GHz, 5.8 GHz and 6-7 GHz, respectively.

In some embodiments, after receiving the multi-band transmission connection response message frame, the first device sends the data frames on the second channel.

In step 408, the second device receives the data frames on the second channel.

In some embodiments, the at least two frequency bands include: frequency band A, frequency band B, and frequency band C, and if the frequency band A is in the busy state and frequency bands B and C are in the idle state, the first device uses the frequency band B and the frequency band C to send the data frame to the second device.

In summary, in the method provided by the embodiments of the present disclosure, when the first channel is in the busy state and the second channel is in the idle state on the at least two frequency bands, the data frames are sent on the second channel first, thereby ensuring the timeliness of data transmission.

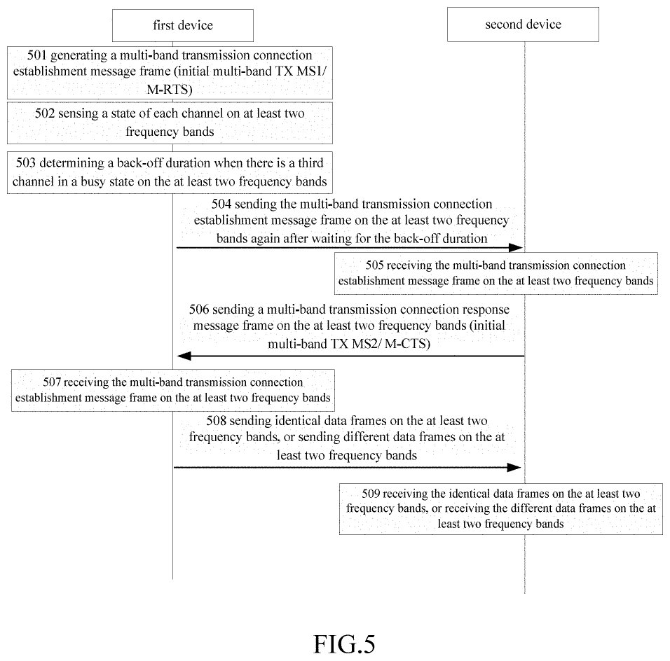

FIG. 5 shows a flowchart of a data transmission method provided by another embodiment of the present disclosure. The method can be executed by the communication system shown in FIG. 1, and includes:

In step 501, the first device generates a multi-band transmission connection establishment message frame, and the multi-band transmission connection establishment message frame is used to request simultaneous transmission of data frames on at least two frequency bands.

The multi-band transmission connection establishment message frame is realized by using a management message frame or a control message frame.

In a case where the management message frame is used to realize the multi-band transmission connection establishment message frame, the management message frame may be an initial multi-band transmission request message frame (initial multi-band TX MS1); and in a case where the control message frame is used to realize the multi-band transmission connection establishment message frame, the control message frame may be a multi-band request to send (M-RTS) message frame.

In step 502, the first device senses a state of each channel on the at least two frequency bands.

The first device senses the state of each channel on the at least two frequency bands by using a clear channel assessment (CCA). For example, an energy detection (ED) mechanism is used at a physical layer to sense a signal strength on the channel in multiple frequency bands; if the sensed signal strength exceeds a threshold, the channel state is determined to be busy; if the sensed signal strength is below the threshold, the channel state is determined to be idle.

In some embodiments, to ensure backward compatibility, the CCA mechanism adopted in the embodiment is consistent with a CCA mechanism in IEEE 802.11a/b/g/n/ac/ax.

In step 503, the first device determines a back-off duration when there is a third channel in the busy state on the at least two frequency bands.

In some embodiments, the first device determines the back-off duration by using a random back-off mechanism. In some embodiments, the first device performs the random back-off mechanism on the sensed busy channel, and a random number m is selected as m=2ⁿ−1, where an initial value of n is 3, the maximum value is 1023, and the back-off duration is m*slotTime, with slotTime=5 us.

In some embodiments, when there are n third channels, the first device determines the corresponding back-off duration for each third channel by using the random back-off mechanism, where n is an integer greater than 1, and the minimum back-off duration among the n back-off durations is determined as the back-off duration for this use.

In step 504, after waiting for the back-off duration, the first device sends the multi-band transmission connection establishment message frame on the at least two frequency bands;

In some embodiments, after waiting for the back-off duration, the first device senses the state of each channel on the at least two frequency bands again; when the state of each channel on the at least two frequency bands is in the idle state, the first device sends the multi-band transmission connection establishment message frame on the at least two frequency bands, and step 505 is entered; when for the state of each channel on the at least two frequency bands, there is the third channel in the busy state, the step 503 is executed again.

In the step 505, the second device receives the multi-band transmission connection establishment message frame on the at least two frequency bands.

In step 506, the second device replies with the multi-band transmission connection response message frame on the at least two frequency bands.

The multi-band transmission connection response message frame is realized by using the management message frame or the control message frame. When the second device determines that a data receiving condition is met (for example, there is no conflicting transmission of a hidden node), the second device replies with the multi-band transmission connection response message frame on the at least two frequency bands.

In a case where the management message frame is used to realize the multi-band transmission connection response message frame, the management message frame may be an initial multi-band transmission response message frame (initial multi-band TX MS2); and in a case where the control message frame is used to realize the multi-band transmission connection response message frame, the control message frame may be a multi-band clear to send (M-CTS) message frame.

In step 507, the first device receives the multi-band transmission connection response message frame on the at least two frequency bands.

In step 508, the first device sends the identical data frames on the at least two frequency bands; or, sends the different data frames on the at least two frequency bands.

The different data frames are obtained after the data to be sent is divided into the blocks.

In some embodiments, after receiving the multi-band transmission connection response message frame, the first device simultaneously sends the identical data frames on the at least two frequency bands; or, simultaneously sends the different data frames on the at least two frequency bands.

The different data frames are obtained after the data to be sent is divided into the blocks. The data in the different data frames refers to upper layer data, and the upper layer data can be divided into the blocks through a media access control (MAC) layer inside a device. For example, after 100M bytes of data are divided into three blocks and numbered as three different data frames of Block1, Block2 and Block3, these three data frames are transmitted on the frequency bands of 2.4 GHz, 5.8 GHz and 6-7 GHz, respectively; or, the data is divided into the blocks and numbered above the MAC layer inside the device, and transparently transmitted to the MAC layer, after the data is re-encapsulated by the MAC layer to obtain three different data frames, these three data frames are transmitted on the frequency bands of 2.4 GHz, 5.8 GHz and 6-7 GHz, respectively.

The data in the identical data frames also refers to the upper layer data, which can be processed by the MAC layer inside the device to be added with different identifications for transmission on different frequency bands. For example, identification 1 indicates that the data is transmitted on the 2.4 GHz frequency band, identification 2 indicates that the data is transmitted on the 5.8 GHz frequency band, and identification 3 indicates that the data is transmitted on the 6-7 GHz frequency band; or the data is processed by the upper layer, and is transparently transmitted to the MAC layer. After being encapsulated into the data frame by the MAC layer, the data is transmitted on the frequency bands of 2.4 GHz, 5.8 GHz and 6-7 GHz, respectively.

In step 509, the second device receives the identical data frames on the at least two frequency bands; or, receives the different data frames on the at least two frequency bands.

In summary, in the method provided by the embodiments of the present disclosure, when the channel is busy during the transmission on the multiple frequency bands, data transmission opportunities are regained by using the random back-off mechanism on the multiple frequency bands, thereby providing another data transmission method when the channel is busy, and achieving greater transmission rate and throughput

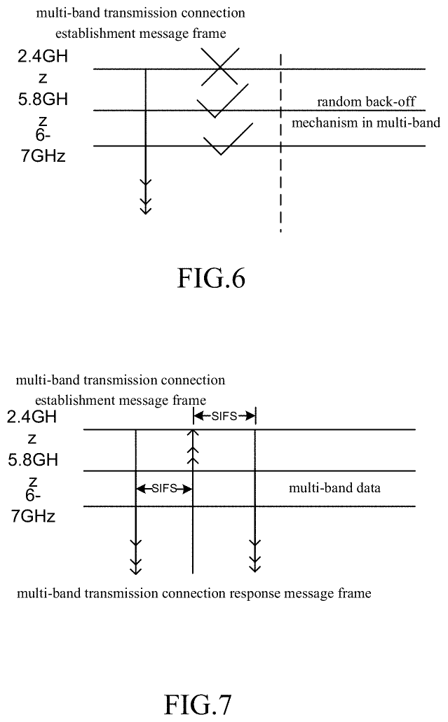

In some embodiments, as shown in FIG. 6, both the first device and the second device support the simultaneous transmission of data frames on the frequency bands of 2.4 GHz, 5.8 GHz, and 6-7 GHz. The first device performs the CCA before sending the multi-band transmission establishment message frame. When it is found that the channel on 2.4 GHz is in the busy state, the back-off duration is determined by using the random back-off mechanism, after waiting for the back-off duration, and channels on the three frequency bands are all in the idle state, the first device sends the multi-band transmission establishment message frame on the three frequency bands of 2.4 GHz frequency band, 5.8 GHz frequency band and 6-7 GHz frequency band.

It should be noted that sending times of the multi-band transmission connection establishment message frame on the at least two frequency bands are synchronized, and sending times of the multi-band transmission connection response message frame on the at least two frequency bands are synchronized, as shown in FIG. 7. An interval between the multi-band transmission connection establishment message frame and the multi-band transmission connection response message frame is a short inter-frame space (SIFS). In order to ensure clock synchronization on each frequency band, even if the MCS used for data transmission on each frequency band is different, inconsistent parts of time can be filled and complemented for alignment.

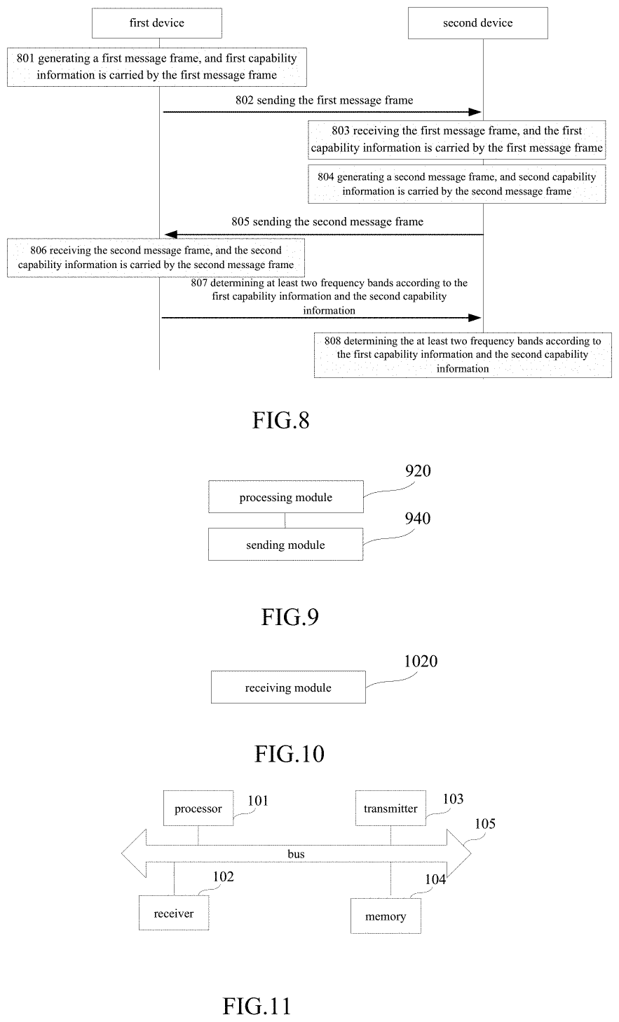

In an embodiment based on the above-mentioned FIG. 2, FIG. 3, FIG. 4, or FIG. 5, when the first device and the second device make an initial connection, they need to inform both parties of capability information values for simultaneous communication on the at least two frequency bands. In this case, before the first device sends the multi-band transmission connection establishment message frame on the at least two frequency bands, the following steps are further included, as shown in FIG. 8:

In step 801, the first device generates a first message frame, and the first message frame carries first capability information, and the first capability information is used to indicate that simultaneous data transmission on at least two frequency bands is supported by the first device.

The at least two frequency bands include: at least two frequency bands of the 2.4 GHz frequency band, the 5.8 GHz frequency band, and the 6-7 GHz frequency band. In some embodiments, the at least two frequency bands also include other communication frequency bands supported by a Wi-Fi protocol. In the following embodiments, the 2.4 GHz frequency band is referred to as frequency band A for short, the 5.8 GHz frequency band is referred to as frequency band B for short, and the 6-7 GHz frequency band is referred to as frequency band C for short.

In some embodiments, the first message frame is a multi-band operation request frame.

In some embodiments, when there is a large amount of data needed to be sent by the first device, the first device generates the first message frame.

In step 802, the first device sends the first message frame.

The first device sends the first message frame on a single frequency band. The single frequency band may be a first frequency band, and the single frequency band is a frequency band with which the first device and the second device have established an association.

In step 803, the second device receives the first message frame, and the first message frame carries the first capability information, and the first capability information is used to indicate that the simultaneous data transmission on the at least two frequency bands is supported by the first device.

The second device receives the first message frame on the single frequency band. For example, the second device receives the first message frame on the first frequency band.

In step 804, the second device generates a second message frame, and the second message frame carries second capability information, and the second capability information is used to indicate that the simultaneous data transmission on the at least two frequency bands is supported by the second device.

In some embodiments, the second message frame is a multi-band operation response frame.

In step 805, the second device sends the second message frame.

The second device sends the second message frame on the single frequency band, and the single frequency band may be the first frequency band.

In step 806, the first device receives the second message frame, and the second message frame carries the second capability information, and the second capability information is used to indicate that the simultaneous data transmission on the at least two frequency bands is supported by the second device.

The first device receives the second message frame on the single frequency band. For example, the first device receives the second message frame on the first frequency band.

In step 807, the first device determines the at least two frequency bands according to the first capability information and the second capability information.

The first device determines a transmission capability supported by both the first device and the second device according to the first capability information and the second capability information, that is, the at least two frequency bands supported by both the first device and the second device.

In some embodiments, the at least two frequency bands include the first frequency band and a second frequency band, the first frequency band is a frequency band used to send the first message frame and the second message frame, and the second frequency band is a frequency band different from the first frequency band.

In step 808, the second device determines the at least two frequency bands according to the first capability information and the second capability information.

The second device determines a transmission capability supported by both the first device and the second device according to the first capability information and the second capability information, that is, the at least two frequency bands supported by both the first device and the second device.

In an embodiment based on FIG. 8, the first capability information and the second capability information include the following information item: frequency band identifications of the at least two frequency bands.

In some embodiments, the first capability information further includes: at least one of an operating bandwidth supported by the first device, a MCS or key reuse information.

In some embodiments, the second capability information further includes: at least one of the operating bandwidth supported by the second device, the MCS or key reuse acknowledgement information.

The operating bandwidth is at least one of a combination of 20 MHz, 40 MHz, 80 MHz, 80+80 MHz (discontinuous, non-overlapping)/160 MHz (continuous), 160+160 MHz (discontinuous, non-overlapping)/320 MHz.

The key reuse information is used to indicate that an existing key (a key on the first frequency band) is reused for data encryption.

In some embodiments, 8 bits are used to indicate the frequency band and the operating bandwidth. The number of frequency band identifications is the same as the number of frequency bands. Taking the frequency bands including the 2.4 GHz frequency band, the 5.8 GHz frequency band and the 6-7 GHz frequency band as an example, the frequency band identifications occupy the first 3 bits of the 8 bits, and a first bit of the first 3 bits corresponds to the 2.4 GHz frequency band, a second bit corresponds to the 5.8 GHz frequency band, and a third bit corresponds to the 6-7 GHz frequency band.

When a value of the first bit is 1, it means that the communication on the 2.4 GHz frequency band is supported, and when the value of the first bit is 0, it means that the communication on the 2.4 GHz frequency band is not supported. When a value of the second bit is 1, it means that the communication on the 5.8 GHz frequency band is supported, and when the value of the second bit is 0, it means that the communication on the 5.8 GHz frequency band is not supported. When a value of the third bit is 1, it means that the communication on the 6-7 GHz frequency band is supported, and when the value of the third bit is 0, it means that the communication on the 6-7 GHz frequency band is not supported.

The last 5 bits of the 8 bits are used to indicate the operating bandwidth. A fourth bit corresponds to 20 MHz, a fifth bit corresponds to 40 MHz, a sixth bit corresponds to 80 MHz, a seventh bit corresponds to 80+80 MHz (discontinuous, non-overlapping)/160 MHz (continuous), and an eighth bit corresponds to 160+160 MHz (discontinuous, non-overlapping)/320 MHz. When a bit value is 1, it means that the corresponding operating bandwidth is supported, and when the bit value is 0, it means that the corresponding operating bandwidth is not supported.

In some embodiments, each of the foregoing information items is represented by an information element (IE). The IE is a component of a frame (such as a management message frame) with a variable length. In some embodiments, the IE includes an element identification (ID) bit, a length bit, and a content bit with a variable length. The length bit is used to indicate the number of content bits. Each information item among the above-mentioned information items may occupy one IE, or two or more information items may occupy the same IE. The element ID of the IE can be represented by a reserved bit in related art, such as 11-15, 43-49, 50-255, etc.

In an embodiment based on FIG. 8, the first message frame is a beacon frame, and the second message frame is an association request frame; or, the first message frame is a probe request frame, and the second message frame is a probe response frame; or, the first message frame is an association request frame, and the second message frame is an association response frame; or, the first message frame is an authentication request frame, and the second message frame is an authentication response frame.

The following are apparatus embodiments of the present disclosure. For details that are not described in detail in the apparatus embodiments, reference may be made to the above-mentioned method embodiments.

FIG. 9 shows a block diagram of a data transmission apparatus provided by another embodiment of the present disclosure. The apparatus can be implemented as all or part of the first device by means of software, hardware or a combination of the software and the hardware, and includes:

a processing module 920, configured to generate a multi-band transmission connection establishment message frame, and the multi-band transmission connection establishment message frame is used to request simultaneous transmission of data frames on at least two frequency bands;

a sending module 940, configured to send the multi-band transmission connection establishment message frame on the at least two frequency bands; and

the sending module 940 is further configured to send the data frames on all or part of the at least two frequency bands.

The processing module 920 may be a hardware device such as a central processing unit or a baseband processor, and is configured to implement steps related to calculation, generation, and processing. The sending module 940 may be a hardware device such as a radio frequency antenna, and is configured to implement steps related to sending.

In an embodiment, the multi-band transmission connection establishment message frame includes:

an initial multi-band transmission request message frame (initial multi-band TX MS1); or

a multi-band request to send (M-RTS) message frame.

In an embodiment, the sending module is configured to sense a state of each channel on the at least two frequency bands; and send the multi-band transmission connection establishment message frame on the at least two frequency bands when the at least two frequency bands are all in an idle state;

the sending module 940 is configured to send identical data frames; or send different data frames on the at least two frequency bands, and the different data frames are obtained after data to be sent is divided into blocks.

In an embodiment, the sending module 940 is configured to sense a state of each channel on the at least two frequency bands; and when there is a first channel in a busy state and a second channel in an idle state on the at least two frequency bands, send the multi-band transmission connection establishment message frame on the second channel;

the sending module 940 is configured to send the data frames on the second channel.

In an embodiment, the sending module 940 is configured to send the data frames on the second channel when the at least two frequency bands are used to send identical data frames; and send a data frame with the smallest frame number among multiple data frames that have not been sent on the second channel when the at least two frequency bands are used to send different data frames.

In an embodiment, the sending module 940 is configured to sense a channel state on the at least two frequency bands;

the processing module 920 is configured to determine a back-off duration when there is a third channel in a busy state on the at least two frequency bands; and

the sending module 940 is configured to send the multi-band transmission connection establishment message frame on the at least two frequency bands again after waiting for the back-off duration.

In an embodiment, the processing module 920 is configured to determine the back-off duration by using a random back-off mechanism.

In an embodiment, the processing module 920 is configured to determine the corresponding back-off duration for each third channel by using the random back-off mechanism when there are n third channels, where n is an integer greater than 1; and determine a minimum back-off duration among the n back-off durations as the back-off duration.

In an embodiment, sending times of the multi-band transmission connection establishment message frame on the at least two frequency bands are synchronized.

FIG. 10 shows a block diagram of a data transmission apparatus provided by another embodiment of the present disclosure. The apparatus can be implemented as all or part of the second device by means of software, hardware or a combination of the software and the hardware, and includes:

a receiving module 1020, configured to receive a multi-band transmission connection establishment message frame on at least two frequency bands, and the multi-band transmission connection establishment message frame is used to request simultaneous transmission of data frames on at least two frequency bands; and

the receiving module 1020 is further configured to receive the data frames on all or part of the at least two frequency bands.

The receiving module 1020 is a hardware device such as the radio frequency antenna, and is configured to implement steps related to reception.

In an embodiment, the receiving module 1020 is configured to receive identical data frames on the at least two frequency bands; or, the receiving module 1020 is configured to receive different data frames on the at least two frequency bands, and the different data frames are obtained after data to be sent is divided into blocks;

the data frames are sent when the at least two frequency bands are all in an idle state.

In an embodiment, the receiving module 1020 is configured to receive the data frames on a second channel on the at least two frequency bands, and the second channel is a channel in the idle state on the at least two frequency bands.

FIG. 11 shows a schematic structural diagram of a wireless communication device provided by an embodiment of the present disclosure. The wireless communication device may be the first device or the second device. The wireless communication device includes: a processor 101, a receiver 102, a transmitter 103, a memory 104, and a bus 105.

The processor 101 includes one or more processing cores, and the processor 101 executes various functional applications and information processing by running software programs and modules.

The receiver 102 and the transmitter 103 may be implemented as one communication component, and the communication component may be a communication chip.

The memory 104 is connected to the processor 101 through the bus 105.

The memory 104 may be configured to store at least one instruction, and the processor 101 is configured to execute the at least one instruction, so as to implement each step in the foregoing method embodiments.

In addition, the memory 104 can be implemented by any type of volatile or non-volatile storage device or a combination of these storage devices. The volatile or non-volatile storage device includes, but is not limited to: a magnetic disk or an optical disk, an electrically erasable and programmable read-only memory (EEPROM), an erasable programmable read-only memory (EPROM), a static random access memory (SRAM), a read-only memory (ROM), a magnetic memory, a flash memory, a programmable read-only memory (PROM).

An embodiment of the present disclosure also provides a computer-readable storage medium in which at least one instruction, at least one program, a code set or an instruction set is stored, and the at least one instruction, the at least one program, the code set or the instruction set is loaded and executed by a processor to implement each step in the foregoing method embodiments.

The beneficial effects brought by the technical solutions provided by the embodiments of the present disclosure include at least:

by generating the multi-band transmission connection establishment message frame which is used to request the simultaneous transmission of the data frame on the at least two frequency bands, and sending the multi-band transmission connection establishment message frame, the data frame is sent on all or part of the at least two frequency bands, thereby achieving simultaneous data transmission on multiple frequency bands, and providing greater transmission rate and throughput.

Those of ordinary skill in the art should know that all or part of the steps described in the above embodiments can be completed through hardware, and may also be completed through related hardware instructed by a program. The program may be stored in a computer-readable storage medium. The storage medium may be a read-only memory, a magnetic disk, an optical disc or the like.

The above descriptions are only preferred embodiments of the present disclosure and are not intended to limit the present disclosure. Any modification, equivalent replacement, improvement and the like within the spirit and principle of the present disclosure shall be included in the protection scope of the present disclosure.

1. A data transmission method, comprising:
generating a multi-band transmission connection establishment message frame, wherein the multi-band transmission connection establishment message frame is used to request simultaneous transmission of data frames on at least two frequency bands;
sending the multi-band transmission connection establishment message frame on the at least two frequency bands; and
sending the data frames on all or part of the at least two frequency bands.

2. The method according to claim 1, wherein the multi-band transmission connection establishment message frame comprises:
an initial multi-band transmission request message frame; or
a multi-band request to send message frame.

3. The method according to claim 1, wherein sending the multi-band transmission connection establishment message frame on the at least two frequency bands comprises:
sensing a state of each channel on the at least two frequency bands; and
sending the multi-band transmission connection establishment message frame on the at least two frequency bands in response to determining that the at least two frequency bands are all in an idle state;
wherein sending the data frames on all or part of the at least two frequency bands comprises:
sending identical data frames on the at least two frequency bands; or sending different data frames on the at least two frequency bands, wherein the different data frames are obtained after data to be sent is divided into blocks.

4. The method according to claim 1, wherein sending the multi-band transmission connection establishment message frame on the at least two frequency bands comprises:
sensing a state of each channel on the at least two frequency bands; and
in response to sensing a first channel in a busy state and a second channel in an idle state on the at least two frequency bands, sending the multi-band transmission connection establishment message frame on the second channel;
wherein sending the data frames on all or part of the at least two frequency bands comprises:
sending the data frames on the second channel.

5. The method according to claim 4, wherein sending the data frames on the second channel comprises:
sending the data frames on the second channel in response to determining that the at least two frequency bands are used to send identical data frames; and
sending a data frame with the smallest frame number among multiple data frames that have not been sent on the second channel in response to determining that the at least two frequency bands are used to send different data frames.

6. The method according to claim 1, wherein sending the multi-band transmission connection establishment message frame on the at least two frequency bands comprises:
sensing a channel state on the at least two frequency bands; and
determining a back-off duration in response to determining a third channel in a busy state on the at least two frequency bands; and
sending the multi-band transmission connection establishment message frame on the at least two frequency bands after waiting for the back-off duration.

7. The method according to claim 6, wherein determining the back-off duration comprises:
determining the back-off duration by using a random back-off mechanism.

8. The method according to claim 7, wherein determining the back-off duration comprises:
determining a corresponding back-off duration for each third channel by using the random back-off mechanism in response to determining n third channels, where n is an integer greater than 1; and
determining a minimum back-off duration among n back-off durations as the back-off duration.

9. The method according to claim 1, wherein:
sending times of the multi-band transmission connection establishment message frame on the at least two frequency bands are synchronized.

10. A data transmission method, comprising:
receiving a multi-band transmission connection establishment message frame on at least two frequency bands, wherein the multi-band transmission connection establishment message frame is used to request simultaneous transmission of data frames on at least two frequency bands; and
receiving the data frames on all or part of the at least two frequency bands.

11. The method according to claim 10, wherein receiving the data frames on all or part of the at least two frequency bands comprises:
receiving identical data frames on the at least two frequency bands; or
receiving different data frames on the at least two frequency bands, wherein the different data frames are obtained after data to be sent is divided into blocks;
wherein the data frames are sent in response to determining that the at least two frequency bands are all in an idle state.

12. The method according to claim 10, wherein receiving the data frames on all or part of the at least two frequency bands comprises:
receiving the data frames on a second channel on the at least two frequency bands, wherein the second channel is a channel in an idle state on the at least two frequency bands.

13. A data transmission apparatus, comprising:
at least one processor; and
a memory for storing executable instructions of the at least one processor;
wherein, the at least one processor is configured to execute following operations when executing the executable instructions:
generating a multi-band transmission connection establishment message frame, wherein the multi-band transmission connection establishment message frame is used to request simultaneous transmission of data frames on at least two frequency bands;
sending the multi-band transmission connection establishment message frame on the at least two frequency bands; and
sending the data frames on all or part of the at least two frequency bands.

14. The apparatus according to claim 13, wherein the multi-band transmission connection establishment message frame comprises:
an initial multi-band transmission request message frame; or
a multi-band request to send message frame.

15. The apparatus according to claim 13, wherein:
the at least one processor is further configured to sense a state of each channel on the at least two frequency bands; and send the multi-band transmission connection establishment message frame on the at least two frequency bands in response to determining that the at least two frequency bands are all in an idle state; and
the at least one processor is further configured to send identical data frames on the at least two frequency bands; or send different data frames on the at least two frequency bands, wherein the different data frames are obtained after data to be sent is divided into blocks.

16. The apparatus according to claim 13, wherein:
the at least one processor is further configured to sense a state of each channel on the at least two frequency bands; and in response to sensing a first channel in a busy state and a second channel in an idle state on the at least two frequency bands, send the multi-band transmission connection establishment message frame on the second channel; and
the at least one processor is further configured to send the data frames on the second channel.

17. The apparatus according to claim 16, wherein:
the at least one processor is further configured to send the data frames on the second channel in response to determining that the at least two frequency bands are used to send identical data frames; and send a data frame with the smallest frame number among multiple data frames that have not been sent on the second channel in response to determining that the at least two frequency bands are used to send different data frames.

18. The apparatus according to claim 13, wherein:
the at least one processor is further configured to sense a channel state on the at least two frequency bands;
the at least one processor is further configured to determine a back-off duration in response to determining a third channel in a busy state on the at least two frequency bands; and
the at least one processor is further configured to send the multi-band transmission connection establishment message frame on the at least two frequency bands again after waiting for the back-off duration.

19. The apparatus according to claim 18, wherein:
the at least one processor is further configured to determine the back-off duration by using a random back-off mechanism.

20-27. (canceled)

28. A data transmission apparatus, comprising:
at least one processor; and
a memory for storing executable instructions of the at least one processor;
wherein the at least one processor is configured to execute the method according to claim 10.
